(19) United States
(12) Patent Application Publication
(10) Pub. No.: US 2015/0030483 A1
(43) Pub. Date: Jan. 29, 2015

(54) PUMP UNIT OF ELECTRONIC CONTROL BRAKE SYSTEM

(71) Applicant: MANDO CORPORATION, Pyeongtaek-si (KR)

(72) Inventor: Dong-Yo RYU, Seongnam-si (KR)

(73) Assignee: MANDO CORPORATION, Pyeongtaek-si (KR)

(21) Appl. No.: 14/308,416

(22) Filed: Jun. 18, 2014

(30) Foreign Application Priority Data
Jul. 25, 2013 (KR) 10-2013-0087720

(51) Int. Cl. B60T 10/04; B60T 13/14

(52) U.S. Cl. CPC B60T 10/04; B60T 13/143
USPC 417/539

(57) ABSTRACT

Disclosed is a pump unit of an electronic control brake system installed in a bore formed in a modulator block, the pump unit including a motor having a rotating shaft, a carrier having a center portion thereof installed on the rotating shaft, and provided with connecting shafts that are spaced apart from the center portion to both sides by a predetermined interval to be disposed in line with each other, a pressing member installed on each of the connecting shafts, and a first piston pump and a second piston pump each provided with a piston configured to be reciprocated by making contact with an outer circumferential surface of the pressing member according to rotation of the carrier, the first piston pump and the second piston pump disposed in line with each other.

### CROSS-REFERENCE TO RELATED APPLICATIONS

This application claims the benefit of Korean Patent Application No. 2013-0087720, filed on Jul. 25, 2013 in the Korean Intellectual Property Office, the disclosure of which is incorporated herein by reference.

### BACKGROUND

1. Field

Embodiments of the present invention relate to a pump unit of an electronic control brake system, and more particularly, to a pump unit of an electronic control brake system capable of reducing vibration and noise generated at the time of operation of a piston pump by improving a structure to operate the piston pump.

2. Description of the Related Art

In general, an electronic control brake system is designed to obtain a powerful and stable braking force by effectively preventing slippage of a vehicle, and the electronic control brake system has been developed in several divisions: an anti-lock brake system (ABS) for preventing skidding of wheels at the time of braking, a brake traction control system (BTCS) for preventing slipping of wheels at the time of a sudden unintended acceleration or a sudden acceleration of a vehicle, and a vehicle dynamic control (VDC) system for maintaining a stable driving condition of a vehicle.

The electronic control brake system includes a plurality of solenoid valves configured to control a hydraulic braking pressure transmitted to a hydraulic brake mounted at a wheel, a low pressure accumulator configured to temporarily store oil discharged from the hydraulic brake, a motor and a piston pump configured to forcedly pump oil in the low pressure accumulator, and an electronic control unit (ECU) configured to control the solenoid valves and the motor. These components of the electronic control brake system are accommodated in a modulator block formed of aluminum in a compact structure.

According the electronic control brake system, oil in the low pressure accumulator is compressed and pumped by operation of the piston pump, and the compressed oil is transmitted to the hydraulic brake or a master cylinder, leading to an electronic control on wheels. In general, a piston pump driven by a motor is provided in the form of a dual pump having two piston pumps combined to a single motor, and such a piston pump used in an electronic control brake system is disclosed in Korean Patent Application No. 10-2009-0043124. Referring to the published document, a piston pump is provided in one pair of piston pumps diametrically opposite to each other with respect to a rotating shaft of a motor, and an eccentric member implemented using an eccentric bearing is installed on the rotating shaft of the motor such that oil in the piston pump is suctioned and discharged as the one pair of piston pumps performs a reciprocating motion.

Alternatively, the rotating shaft of the motor may be provided in the form of an eccentric drive shaft, and an eccentric member installed on the eccentric drive shaft may be implemented as a concentric bearing.

When the piston of the piston pump driven by a single motor performs a reciprocating motion, for example, when the piston moves from a top dead center to a bottom dead center, a repulsive force is generated in a linear direction in which the piston is moved, causing vibration and noise. That is, one pair of piston pumps alternately generates a repulsive force through pistons in a direction of the motor shaft, vibration and noise occur. The bottom dead center represents a suction process state in which the piston moves toward the rotating shaft of the motor and thus oil is introduced into the piston pump, representing the lowest position of the piston in which the movement of the piston is limited. The top dead center represents a discharge process state in which the piston moves away from the rotating shaft of the motor and thus oil in the piston pump is discharged, representing the highest position of the piston in which movement of the piston is limited.

In addition, a rotary force generated by the motor is provided in the form of an eccentric rotary force by the eccentric bearing or the eccentric shaft, and such a structural feature causes weight imbalance, leading to vibration and noise at the time of eccentric rotation.

### PRIORITY ART DOCUMENTS

Korean Patent Publication No. 10-2009-0043124 (Mando Corporation), dated May 6, 2009.

### SUMMARY

Therefore, it is an aspect of the present invention to provide a pump unit of an electronic control brake system capable of offsetting a repulsive force generated by a piston and reducing vibration and noise, by arranging at least one pair of piston pumps in line with each other, and disposing a pressing member configured to pump the piston pumps so as to face the piston.

It is another aspect of the present invention to provide a pump unit of an electronic control brake system capable of ensuring a weight balance by preventing a center of gravity of a pressing member configured to pump a piston of a piston pump from being eccentrically positioned from the center of a rotating shaft of a motor, and also capable of preventing vibration and noise caused by an eccentric rotation in the conventional technology.

Additional aspects of the invention will be set forth in part in the description which follows and, in part, will be obvious from the description, or may be learned by practice of the invention.

In accordance with one aspect of the present invention, a pump unit of an electronic control brake system installed in a bore formed in a modulator block, the pump unit including: a motor having a rotating shaft; a carrier having a center portion thereof installed on the rotating shaft, and provided with connecting shafts that are spaced apart from the center portion to both sides by a predetermined interval to be disposed in line with each other; a pressing member installed on each of the connecting shafts; and a first piston pump and a second piston pump each provided with a piston configured to be reciprocated by making contact with an outer circumferential surface of the pressing member according to rotation of the carrier, the first piston pump and the second piston pump disposed in line with each other.

The pressing member may be a bearing or a roller that is rotatably installed on the connecting member.

The pump unit may further include a third piston pump and a fourth piston pump that may be each provided with a piston reciprocated by making contact with the outer circumferential surface of the pressing member according to rotation of the carrier, the third piston pump and the fourth piston pump disposed in line with each other and spaced apart from the first piston pump and the second piston pump. The first piston pump and the second piston pump may be circumferentially spaced apart from the third piston pump and the fourth piston pump by angles of 90 degrees, respectively, with respect to the carrier, so that the first and second piston pumps perform a pumping operation sequentially with the third and fourth piston pumps.

An edge of each of the pistons which makes contact with the pressing member may be rounded.

As is apparent from the above, the pump unit of the electronic control brake system can offset a repulsive force generated by a piston and reduce vibration and noise by arranging at least one pair of piston pumps in line with each other, and disposing a pressing member configured to pump the piston pump so as to face the piston.

In addition, the pump unit of the electronic control brake system can ensure a weight balance by preventing a center of gravity of a pressing member configured to pump a piston of a piston pump from being eccentrically positioned from the center of a rotating shaft of a motor, and also prevent vibration and noise caused by an eccentric rotation in the conventional technology.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a hydraulic circuit diagram illustrating an electronic control brake system according to an embodiment of the present invention.

FIG. 2 is a view schematically showing an arrangement of a pump unit of FIG. 1.

FIGS. 3 and 4 are views illustrating an operation state of a pump unit of an electronic control brake system according to an embodiment of the present invention.

### DETAILED DESCRIPTION

Reference will now be made in detail to the preferred embodiments of the present invention, examples of which are illustrated in the accompanying drawings. These embodiments are provided so that this disclosure will be thorough and complete, and will fully convey the spirit and scope of the present invention to those skilled in the art. Other embodiments may also be provided. Constituent elements other than elements constituting essential features of the present invention may be omitted from the drawings, for clarity of description. In the drawings, the widths, lengths, and thicknesses of constituent elements may be exaggerated for clarity and convenience of illustration. Like reference numerals refer to like elements throughout.

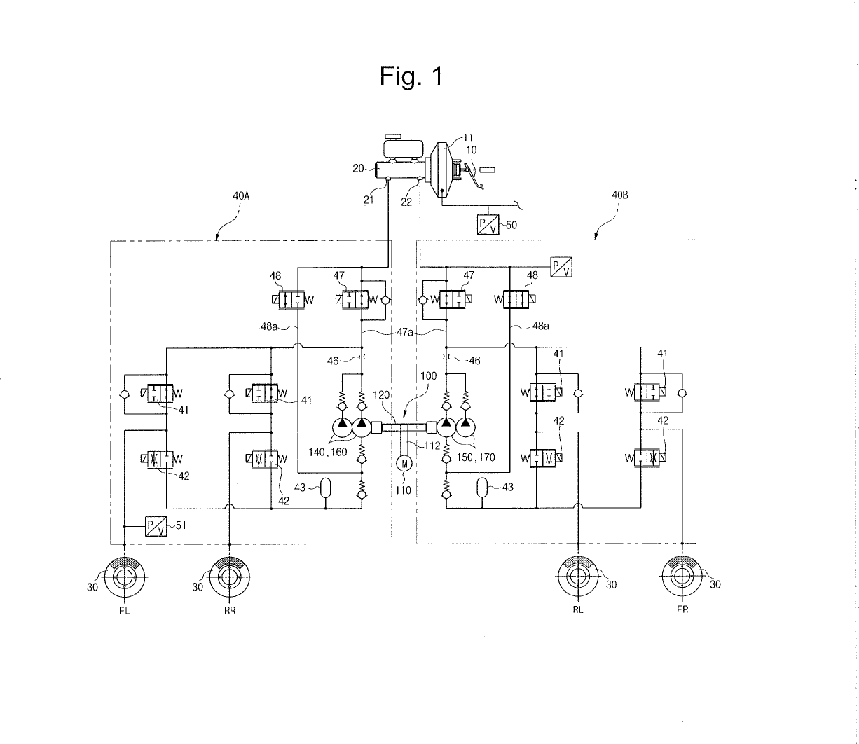

FIG. 1 is a hydraulic circuit diagram illustrating an electronic control brake system according to an embodiment of the present invention.

Referring to FIG. 1, an electronic control brake system adopting the present invention includes a brake pedal 10 that receives an operating force from a driver, a brake booster 11 that receives a stepping force of the brake pedal 10 and amplifies the stepping force by use of a pressure difference between a vacuum pressure and the atmospheric pressure, a master cylinder 20 that allows the brake booster 11 to generate a pressure, a first hydraulic circuit 40A that connects a first port 21 of the master cylinder 20 to certain two wheel brakes (or wheel cylinders) 30 to control transmission of a liquid pressure, and a second hydraulic circuit 40B that connects a second port 22 of the master cylinder 20 to the remaining two wheel brakes 30 to control transmission of a liquid pressure.

Each of the first hydraulic circuit 40A and the second hydraulic circuit 40B includes two solenoid valves 41 and two solenoid valves 42 configured to control a hydraulic braking pressure transmitted to the wheel brakes 30, a low pressure accumulator 43 that temporarily stores oil discharged from the wheel brakes 30 at the time of pressure-reducing braking, a pump unit 100 provided with a motor 110 and a plurality of piston pumps 140, 150, 160 and 170 to pump oil stored in the low pressure accumulator 43 at the time of pressure-increasing/maintaining braking, an orifice 46 configured to reduce a pressure pulsation of a high level of liquid pressure discharged by a pumping operation of the pumping unit 100, and a subsidiary path 48a configured to guide oil of the master cylinder 20 to be suctioned into an inlet of the pump unit 100 in a traction control system (TCS) mode. These components of the first hydraulic circuit 40A and the second hydraulic circuit 40b are accommodated in a modulator block (not shown) in a compact structure.

The plurality of solenoid valves 41 and 42 are in conjunction with upstream and downstream sides of the wheel brake 30, and are divided into a normal open type solenoid valve 41 that is disposed on the upstream side of the wheel brake 30 and remains normally opened and a normal close type solenoid valve 42 that is disposed on the downstream side of the wheel brake 30 and remains normally closed. Opening and closing operations of the solenoid valves 41 and 42 may be controlled by an electronic control unit (ECU) (not shown) configured to sense a vehicle speed through a wheel speed sensor disposed at each wheel, and oil discharged from the wheel brake 30 as the normal close type solenoid valve 42 is opened in accordance with pressure reducing braking may be temporarily stored in the low pressure accumulator 43.

The pump unit 100 according to the present invention may be driven by the motor 110 so as to suction the oil stored in the low pressure accumulator 43 and discharge the oil toward the orifice 46, to transmit a liquid pressure toward the wheel brake 30 or the master cylinder 20.

In addition, installed in a main oil passage 47a for connecting the master cylinder 20 to an outlet of the piston pumps 140, 150, 160 and 170 is a normal open type solenoid valve 47 (hereinafter, referred to as “TC valve”) to control traction control. The TC valve 47 remains normally opened and allows a hydraulic braking pressure generated in the master cylinder 20 at the time of general braking through the brake pedal 10 to be transmitted toward the wheel brake 30 through the main oil passage 47.

In addition, an auxiliary oil passage 48a is branched from the main oil passage 47a and guides oil of the master cylinder 20 to be sucked into the inlet side of a piston pump 44. In the auxiliary oil passage 48a, a shuttle valve 48 for causing the oil to flow only to the inlet of the piston pump 44 is provided. The shuttle valve 48 that is electrically operated is provided in the middle of the auxiliary oil passage 48a so that the shuttle valve 48 is normally closed but opened in a TCS mode.

In addition, on the brake booster 11, a pressure sensor 50 is installed to detect a vacuum pressure of the brake booster 11 and the atmosphere pressure, and on front left and front right side wheels (FL and FR) and rear left and rear right side wheels (RL and RR), a wheel pressure sensor 51 is provided to detect an actual braking pressure applied to the front left and front right side wheels (FL and FR) and rear left and rear right side wheels (RL and RR)). The pressure sensors 50 and 51 are electrically connected to the ECU and controlled.

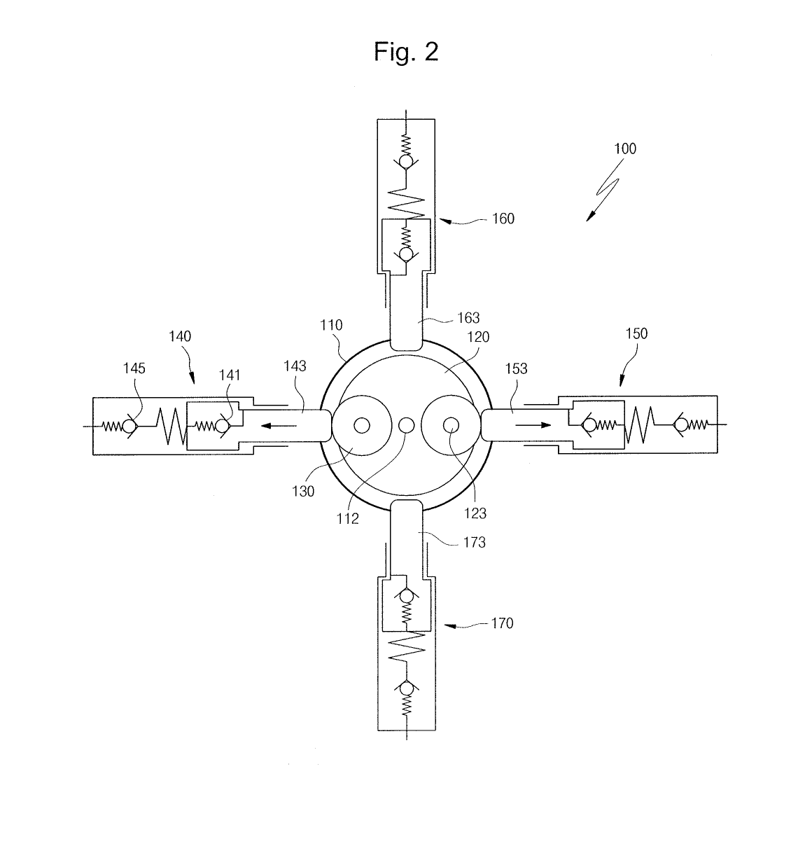

Hereinafter, the structure of the pump unit according to the present invention will be described with reference to FIG. 2.

Referring to FIG. 2, the pump unit 100 includes the motor 110 having a rotating shaft 112, a carrier 120 installed on the rotating shaft 112 of the motor 110, a pressing member 130 installed on the carrier 120, and a plurality of piston pumps 140, 150, 160 and 170 disposed in a radial direction with respect to the motor 110 such that the plurality of piston pumps 140, 150, 160 and 170 perform a pumping operation by the pressing member 130.

The motor 110 is installed at an outer side of the modulator block so as to have the rotating shaft 112 installed in the modulator block, and generates a rotary force to drive the piston pumps 140, 150, 160 and 170. The carrier 120 is installed with the center portion thereof installed on the rotating shaft 112 of the motor 110 such that the carrier 120 has a central shaft identical to that of the rotating shaft 112 of the motor 110.

The carrier 120 is provided with connecting shafts 123 that are spaced apart from the center portion thereof by a predetermined interval and are disposed in line with each other. The pressing members 130 are installed on the connecting shafts 123, respectively.

The pressing member 130 is rotatably installed on the connecting shaft 123 so as to minimize a frictional force at the time of pressing pistons 143, 153, 163 and 173 of the piston pumps 140, 150, 160 and 170, which is to be described later, while making contact with the piston pumps 140, 150, 160 and 170. The pressing member 130 may be implemented using a bearing or a roller. Since the pressing members 130 are disposed while being spaced apart from each other from the center portion of the carrier 120 by a predetermined interval, and the center portion of the carrier 120 is installed on the rotating shaft 112, the center of gravity is not eccentrically provided and the weight balance is kept. That is, the vibration and noise due to eccentric rotation is removed.

The plurality of piston pumps 140, 150, 160 and 170 are disposed while being spaced apart from each other along a circumferential direction at an outer surface of the carrier 120. For example, as shown in FIG. 2, the first piston pump 140 and the second piston pump 150 are disposed at the left side and the right side of the carrier 120, respectively, in line with each other. The third piston pump 160 and the fourth piston pump 170 are disposed at the upper side and the lower side of the carrier 120, respectively, in line with each other. That is, the first to fourth piston pumps 140, 150, 160 and 170 are disposed on the outer circumferential surface of the carrier 120 while being circumferentially spaced apart from each other at an interval of 90 degrees. Accordingly, the pressing member 130 causes the first and second piston pumps 140 and 150 to perform a pumping operation sequentially with the third and fourth piston pumps 160 and 170 according to rotation of the carrier 120.

Meanwhile, since the first to fourth piston pumps 140, 150, 160 and 170 each have the same inner structure, the following description will be described in relation on the first piston pump 140 as an example.

The first piston pump 140 includes the piston 143 provided at an inside thereof with a suction passage (not shown), an inlet valve 141 that opens/closes an exit side of the suction passage depending on the position of the piston 143, and an outlet valve 145 that operates in a manner opposite to the inlet valve 141. Through such a configuration, the piston pumps 140, 150 ,160 and 170 are connected to a suction port (not shown) and a discharge port (not shown) formed on the modulator block so as to suction and compress oil from the suction port and discharge the suctioned oil to the discharge port.

Hereinafter, an operation of the pump unit having the above structure will be described with reference to FIGS. 2 to 4.

Referring to FIG. 2, as the carrier 120 rotates in accordance with driving of the motor 110, the pressing members 130 installed on the carrier 120 are disposed in line with the first and second piston pumps 140 and 150. That is, in accordance with a rotation of the carrier 120, the pressing members 130 press the pistons 143 and 153 of the first and second piston pumps 140 and 150. Accordingly, repulsive forces generated from the pistons 143 and 153 are transmitted to the center of the carrier 120 through the pressing members 130 disposed in line with the pistons 143 and 153, and thus the repulsive force of both sides are offset.

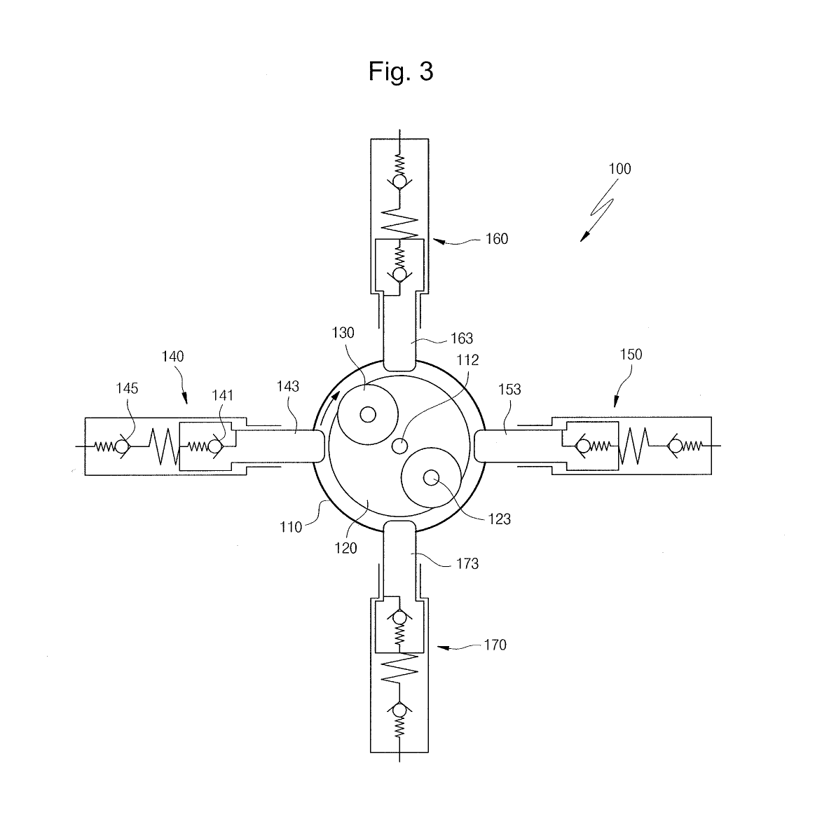

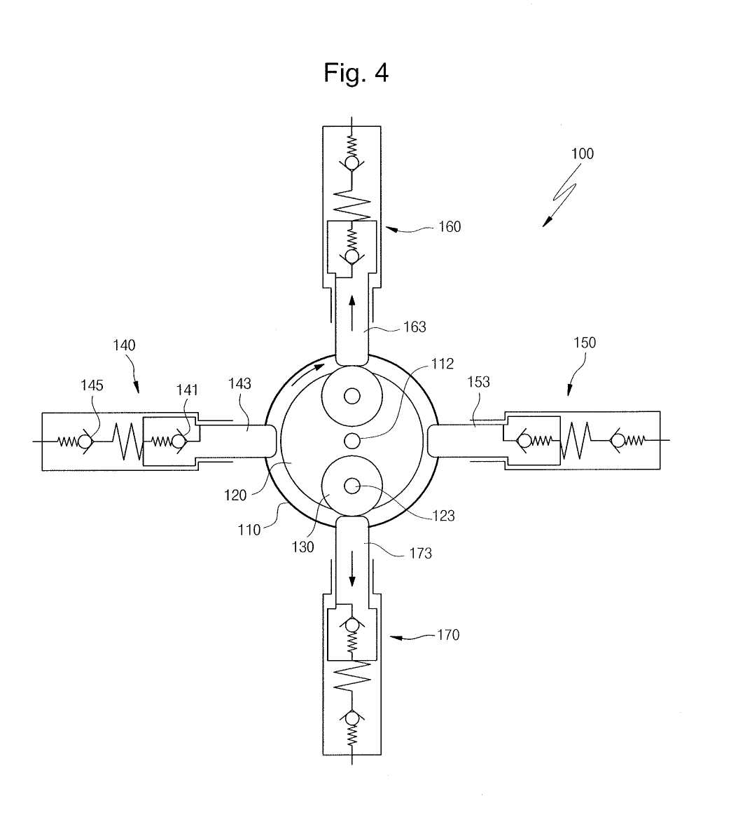

Referring to FIG. 3, as the carrier 120 rotates, the pressing members130 are spaced apart from the first and second pumps 140 and 150, and the pistons 143 and 153 return to the original positions thereof, leading to a suction process. Referring to FIG. 4, as the carrier 120 rotates further, the pressing members 130 press the third and fourth piston pumps 160 and 170 that are circumferentially spaced apart from the first and second piston pumps 140 and 150 by angles of 90 degrees, respectively, the pressing members 130 make contact with the pistons 163 and 173 of the third and fourth piston pumps 160 and 170 and press the pistons 163 and 173. That is, in the same manner as the first and second piston pumps 140 and 150, repulsive forces from the pistons 163 and 173 of the third and fourth piston pumps 160 and 170 are offset, so that vibration and noise are reduced.

As described above, the pressing members 130 rotate during the rotation of the carrier 120, and at the time of pressing the pistons 143, 153, 163 and 173, the pressing members 130 press the pistons 143, 154, 163 and 173 while rotating on the connecting shafts 123 of the carrier 120. That is, the pressing members 130, while rotating, press the pistons 143, 153, 163 and 173, with minimum friction with the pistons 143, 153, 163 and 173.

Meanwhile, edges of the pistons 143, 153, 163 and 173 are rounded so as to minimize impact and friction at the time of contact with the pressing members 130. As described above, as the carrier 120 rotates, the pressing members 130 allow the first and second piston pumps 140 and 150 to perform a pumping operation sequentially with the third and fourth piston pumps 160 and 170, and repulsive forces generated from the pistons 143 and 153 of the first and second piston pumps 140 and 150 disposed in line with each other are offset with each other and repulsive forces of the pistons 163 and 173 of the third and fourth piston pumps 160 and 170 disposed in line with each other are offset with each other, so that vibration and noise are reduced.

Although the above structure of the pump unit 100 is illustrated as including one pair of pressing members 130 disposed in line with each other on the carrier 120 coupled to the motor 110, and four piston pumps 140, 150, 160 and 170 circumferentially disposed at an interval of 90 degrees to perform a pumping operation, the present invention is not limited thereto. The number of the pressing members 130 and the piston pumps may be varied as long as the pressing member 130 and at least one pair of piston pumps are disposed in line with each other.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A pump unit of an electronic control brake system installed in a bore formed in a modulator block, the pump unit comprising:
a motor having a rotating shaft;
a carrier having a center portion thereof installed on the rotating shaft, and provided with connecting shafts that are spaced apart from the center portion to both sides by a predetermined interval to be disposed in line with each other;
a pressing member installed on each of the connecting shafts; and
a first piston pump and a second piston pump each provided with a piston configured to be reciprocated by making contact with an outer circumferential surface of the pressing member according to rotation of the carrier, the first piston pump and the second piston pump disposed in line with each other.

2. The pump unit of claim 1, wherein the pressing member is a bearing or a roller that is rotatably installed on the connecting member.

3. The pump unit of claim 1, further comprising a third piston pump and a fourth piston pump that are each provided with a piston reciprocated by making contact with the outer circumferential surface of the pressing member according to rotation of the carrier, the third piston pump and the fourth piston pump disposed in line with each other and spaced apart from the first piston pump and the second piston pump.

4. The pump unit of clam 3, wherein the first piston pump and the second piston pump are circumferentially spaced apart from the third piston pump and the fourth piston pump by angles of 90 degrees, respectively, with respect to the carrier, so that the first and second piston pumps perform a pumping operation sequentially with the third and fourth piston pumps.

5. The pump unit of claim 3, wherein an edge of each of the piston s which makes contact with the pressing member is rounded.
